(19) United States
(12) Patent Application Publication
(10) Pub. No.: US 2017/0178056 A1
(43) Pub. Date: Jun. 22, 2017

(54) FLEXIBLE BUSINESS TASK FLOW

(71) Applicant: INTERNATIONAL BUSINESS MACHINES CORPORATION, Armonk, NY (US)

(72) Inventors: Jia Huo, Beijing (CN); Xin Pei Lang, Beijing (CN); Bing Li, Beijing (CN); Suo Shi Zheng, Beijing (CN)

(21) Appl. No.: 14/973,824

(22) Filed: Dec. 18, 2015

(51) Int. Cl. G06Q 10/06

(52) U.S. Cl. CPC G06Q 10/063118

(57) ABSTRACT

A method for a flexible business task flow includes: identifying a task flow that includes an order in which to perform a plurality of tasks; receiving an event trigger indicating that a first task of the plurality of tasks has been performed; responsive to receiving the event trigger indicating that the first task has been performed, determining whether a task object associated with the first task includes one or more task routing rules; and determining to perform a second task of the plurality of tasks, wherein if the task object is determined to include one or more task routing rules, the second task is determined according to the one or more task routing rules, and wherein if the task is determined to not include any task routing rules, the second task is determined according to the order of the identified task flow.

### BACKGROUND

The present invention relates generally to the field of business process implementations, and more particularly to flexible routing of business task flows.

Business process implementation, also referred to as business process management (BPM), is a field in operations management that focuses on improving corporate performance by managing and optimizing a company's business processes. BPM can therefore be described as a “process optimization process” that enables organizations to be more efficient, more effective, and more capable of change than a functionally focused, traditional hierarchical management approach. Business processes implementations can have significant impacts on the cost and revenue generation of an organization.

### SUMMARY

Embodiments of the present invention disclose a method, computer program product, and system for a flexible business task flow. The method includes identifying a task flow that includes an order in which to perform a plurality of tasks. The method further includes receiving an event trigger indicating that a first task of the plurality of tasks has been performed. The method further includes, responsive to receiving the event trigger indicating that the first task has been performed, determining whether a task object associated with the first task includes one or more task routing rules. The method further includes determining to perform a second task of the plurality of tasks, wherein if the task object is determined to include one or more task routing rules, the second task is determined according to the one or more task routing rules, and wherein if the task is determined to not include any task routing rules, the second task is determined according to the order of the identified task flow.

### BRIEF DESCRIPTION OF THE DRAWINGS

FIG. 1 is a functional block diagram illustrating a task management environment, in an embodiment in accordance with the present invention.

FIG. 2 is a functional block diagram illustrating task objects in a main task flow, on a server computer within the task management environment of FIG. 1, where each task object has properties that store history information of the task, in an embodiment in accordance with the present invention.

FIG. 3 illustrates a functional block diagram of a task engine in a task management software, on a server computer within the task management environment of FIG. 1, in an embodiment in accordance with the present invention.

FIG. 4A is a flowchart depicting operational steps of a task management software, on a server computer within the task management environment of FIG. 1, for processing an event payload of a user task object to execute a reject command in an embodiment in accordance with the present invention.

FIG. 4B is a flowchart depicting operational steps of a task management software, on a server computer within the task management environment of FIG. 1, for restarting a user's task due to a reject operation in an embodiment in accordance with the present invention.

FIG. 4C is a flowchart depicting operational steps of a task management software, on a server computer within the task management environment of FIG. 1, for resuming a user task object after a reject command in an embodiment in accordance with the present invention.

FIG. 5 is a flowchart depicting operational steps of a task management flow, on a server computer within the task management environment of FIG. 1, for performing a runtime based dynamic routing of a business task flow in an embodiment in accordance with the present invention.

FIG. 6 depicts a block diagram of components of the server computer executing task management software, in an embodiment in accordance with the present invention.

### DETAILED DESCRIPTION

Embodiments in accordance with the present invention recognize that traditional business process implementations follow a pre-designed process and do not support dynamic process routing such as a jumps to new task step(s), call backs, withdraws, task rejections, etc. during runtime. The dynamic assignment of the user/group for a business process is also not typically supported. For example, in a simple document routing scenario, a user, also referred to as a task owner, that receives a new document from another department may need to decide what the right next step for processing the document is. The user may need to create a new task to handle the new document. Additionally, the user may need to decide the correct owner to process the task. In another example scenario, the owner of a work item in a business process may prefer for the backend system to take care of the task routing. In these cases, the real business process might not be able to be pre-designed or pre-defined, and the process or task flow in the real business process may be shaped and determined by the runtime user experience or data analysis. Unfortunately, existing business process products do not typically support this kind of flexibility.

Embodiments of the present invention introduce a flexible task, or process, flow model which allows a user to decide how the task flow is routing at runtime based on the user's knowledge or on a system-defined routing rule. The task flow model builds upon a hierarchical structure object model which includes a traditional process model object at the bottom of the hierarchy and a task model object as a container of the traditional process model object on the second level. The process model object defines the fixed process, and the task model object covers the dynamic task routing and owner assignment. Advantages of the task flow described herein can include: (i) a flexible business task flow can meet requirements of pre-defined task flows, and/or runtime dynamically determined task flows, and (ii) a user's real-time routing requirement and system rules-based task routing may both be addressed.

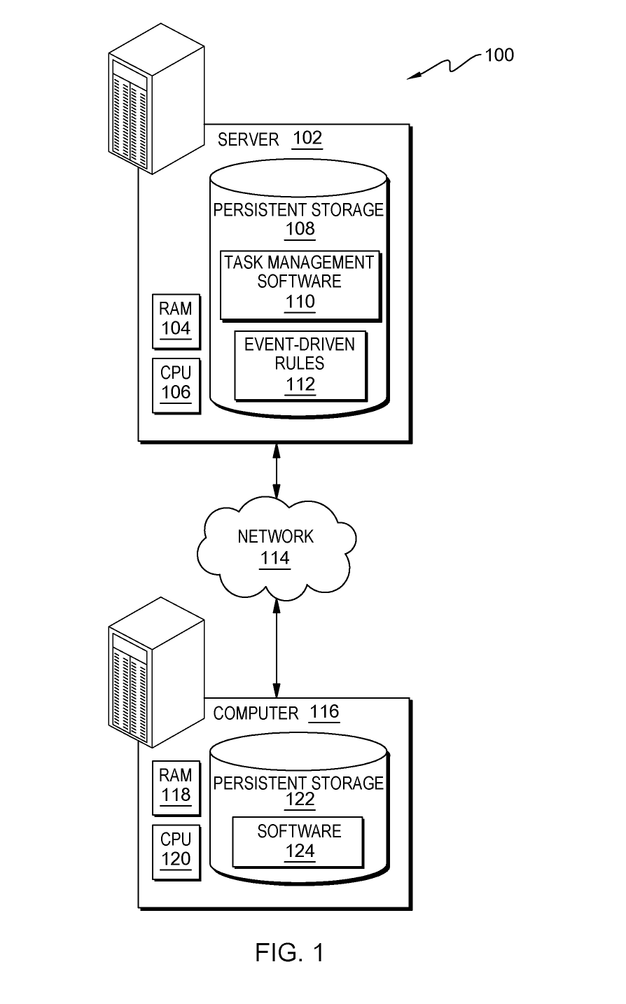

Embodiments in accordance with the present invention will now be described in detail with reference to the Figures. FIG. 1 is a functional block diagram, generally designated 100, illustrating a task management environment, in an embodiment in accordance with the present invention.

Task management environment 100 includes server 102 and computer 116, all interconnected over a data connection to network 114. Server 102 includes random access memory (RAM) 104, central processing unit (CPU) 106, and persistent storage 108. Server 102 may be a Web server, or any other electronic device or computing system, capable of processing program instructions and receiving and sending data. In some embodiments, server 102 may be a laptop computer, a tablet computer, a netbook computer, a personal computer (PC), a desktop computer, a personal digital assistant (PDA), a smart phone, or any programmable electronic device capable of communicating over a data connection to network 118. In other embodiments, server 102 may represent server computing systems utilizing multiple computers as a server system, such as in a distributed computing environment. In general, server 102 is representative of any electronic devices or combinations of electronic devices capable of executing machine-readable program instructions and communicating with computer 116 via network 114 and with various components and devices (not shown) within task management environment 100.

Server 102 includes persistent storage 108. Persistent storage 108 may, for example, be a hard disk drive. Alternatively, or in addition to a magnetic hard disk drive, persistent storage 108 may include a solid state hard drive, a semiconductor storage device, read-only memory (ROM), erasable programmable read-only memory (EPROM), flash memory, or any other computer-readable storage medium that is capable of storing program instructions or digital information. Task management software 110 and event-driven rules 112 are stored in persistent storage 108, which also includes operating system software (not shown), as well as software that enables server 102 to handle “on the fly” flexible task routing, and communicate with other computing devices (not shown) of task management environment 100 over a data connection on network 114.

Task management software 110 are computer programs, or a set of programs, that are stored in persistent storage 108. Task management software 110 may leverage existing object models to implement a flexible routing task flow by using the existing object's system properties and custom properties to store task step information as well as the task routing information. For example, a task object will store the previous task, also referred to a predecessor task, which launches it, and store the parent task information, in the task object's properties. A parent task is any task that contains one or more sub-tasks, or child tasks, that are responsible for collectively performing the functions or operations assigned to the parent task. Task management software 110 may also introduce a task flow engine to handle the routing of the task. When an event is triggered from a task object, or from a user, the task flow engine will receive the event and then launch the following tasks (i.e., next tasks or successor tasks), or child tasks according to the task routing rules defined by a user or system business rules. A next task or successor task is any task that is processed or performed following the completion of a current task. When an event is triggered, the task flow engine will handle the event and terminate or update other tasks according to the relationship between tasks. Task management software 110 may also store the routing history information in a task object to be used for a rollback of a task, or the history routing, of the task flow.

Persistent storage 108 also includes event-driven rules 112. Upon receiving an event triggered by a task object, or from a user, a task flow engine may execute tasks, or child tasks, according to one or more task routing rules defined by user or system business rules in event-driven rules 112. Event-driven rules 112 may contain, for example: (i) a rule for skipping a task of a plurality of tasks in the order of the identified task flow, (ii) a rule for moving a task of a plurality of tasks in the order of the identified task flow, (iii) a rule for inserting a task into an order of the identified task flow, and/or (iv) a rule for performing a child task of a task of a plurality of tasks in the order of the identified task flow.

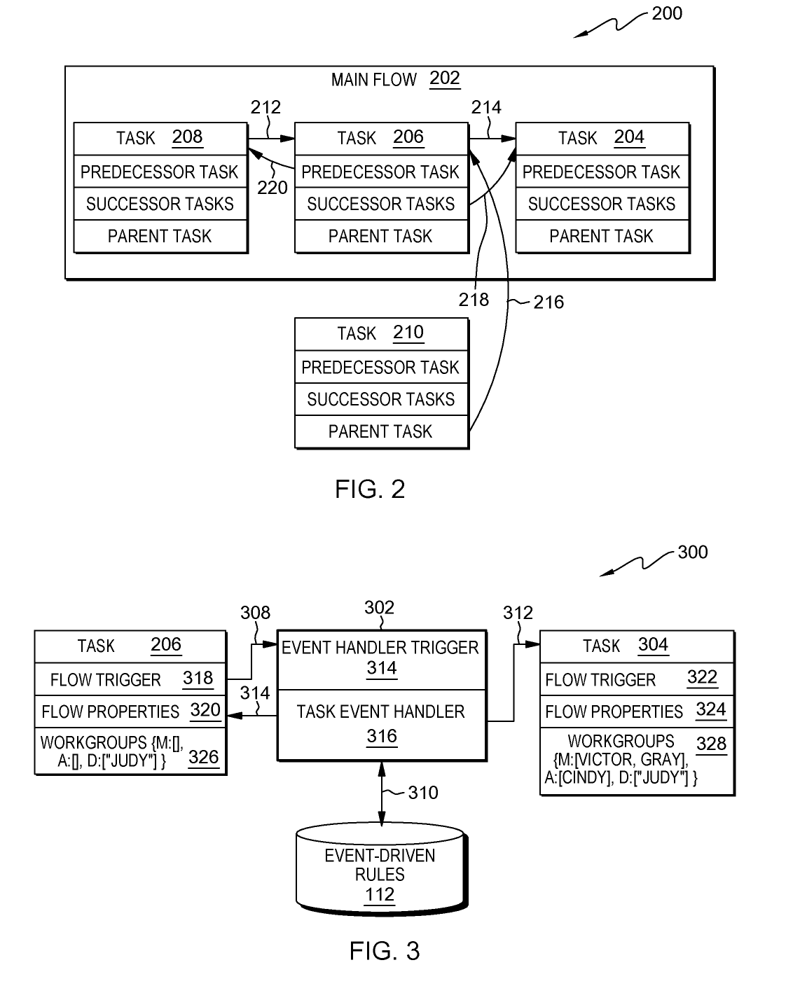

Server 102 may include internal and external hardware components, as depicted and described in further detail with respect to FIGS. 2, 3, and 6.

In FIG. 1, network 114 is shown as the interconnecting fabric between server 102 and with various components and devices (not shown) within task management environment 100. In practice, the connection may be any viable data transport network, such as, for example, a LAN or WAN. Network 114 can be, for example, a local area network (LAN), a wide area network (WAN) such as the Internet, or a combination of the two, and include wired, wireless, or fiber optic connections. In general, network 114 can be any combination of connections and protocols that will support communications between server 102, computer 116 and with various components and devices (not shown) within task management environment 100.

Computer 116 is also included in task management environment 100. Computer 116 includes user random access memory (RAM) 118, central processing unit (CPU) 120, and persistent storage 122. Computer 116 may be a Web server, or any other electronic device or computing system, capable of processing program instructions and receiving and sending data. In some embodiments, computer 116 may be a laptop computer, a tablet computer, a netbook computer, a personal computer (PC), a desktop computer, a personal digital assistant (PDA), a smart phone, or any programmable electronic device capable of communicating over a data connection to network 114. In other embodiments, computer 116 may represent server computing systems utilizing multiple computers as a server system, such as in a distributed computing environment. In general, computer 116 is representative of any electronic devices or combinations of electronic devices capable of executing machine-readable program instructions and communicating with server 102 via network 114 and with various components and devices (not shown) within task management environment 100.

Computer 116 includes persistent storage 122. Persistent storage 122 may, for example, be a hard disk drive. Alternatively, or in addition to a magnetic hard disk drive, persistent storage 122 may include a solid state hard drive, a semiconductor storage device, read-only memory (ROM), erasable programmable read-only memory (EPROM), flash memory, or any other computer-readable storage medium that is capable of storing program instructions or digital information. Software 124 is stored in persistent storage 122, which also includes operating system software, as well as software that enables computer 116 to detect and establish a connection to server 102, and communicate with other computing devices (not shown) of task management environment 100 over a data connection on network 114.

FIG. 2 is a functional block diagram, generally designated 200, illustrating task objects in a main task flow, on a server computer within the task management environment of FIG. 1, where each task object has properties that store history information of the task, in an embodiment in accordance with the present invention. In an example embodiment, task management software 110 uses one or more task objects' system properties and custom properties to store task step information as well as the task routing information. For example, a task object may store a previous task which launched it, and store parent task information, in the task object's properties.

In the example embodiment of FIG. 2, task objects 208, 206, and 204 are task objects in the main task flow 202, also referred to as main flow 202. In main flow 202, the task order is as follows: task 208 is the first task, task 206 is the second task, and task 204 is the third task. Task objects 204, 206, 208, and 210 include properties which store history information of the task, wherein some of the properties point to a previous task (also referred to as a predecessor), a successor task and/or a parent task. Task 210 is a child object of task 206 as indicated by reference indicator 216. In one example embodiment, a user may launch one or more child tasks on the fly outside main flow 202, such as task 210, wherein the one or more child tasks are sub-tasks that include information to indicate a parent task as depicted by reference indicator 216 pointing back to parent task 206. When the one or more child tasks are completed outside main flow 202, the parent task (e.g., task 206), may be updated to indicate the status of the one or more child tasks.

Task 206 is a next task (i.e., successor task), of task 208 in main flow 202 as depicted by reference indicator 212. The next task in the flow is task 204 as depicted by reference indicator 214. A task must be completed before a next task may be triggered. Task 204 is a successor task of task 206 as depicted by reference indicator 218. Task 208 is a predecessor task of task 206 as depicted by reference indicator 220. In one embodiment, prior to launching one or more next tasks (e.g., task 204) of the current task (e.g., task 206), a user may define the relationship between one or more next tasks, wherein the relationship between one or more next tasks may require, for example, one of the following: (i) all next tasks must be completed before processing a next step in the task flow, or (ii) directly go into a next step in the task flow and terminate other tasks as soon as each one of the tasks are completed.

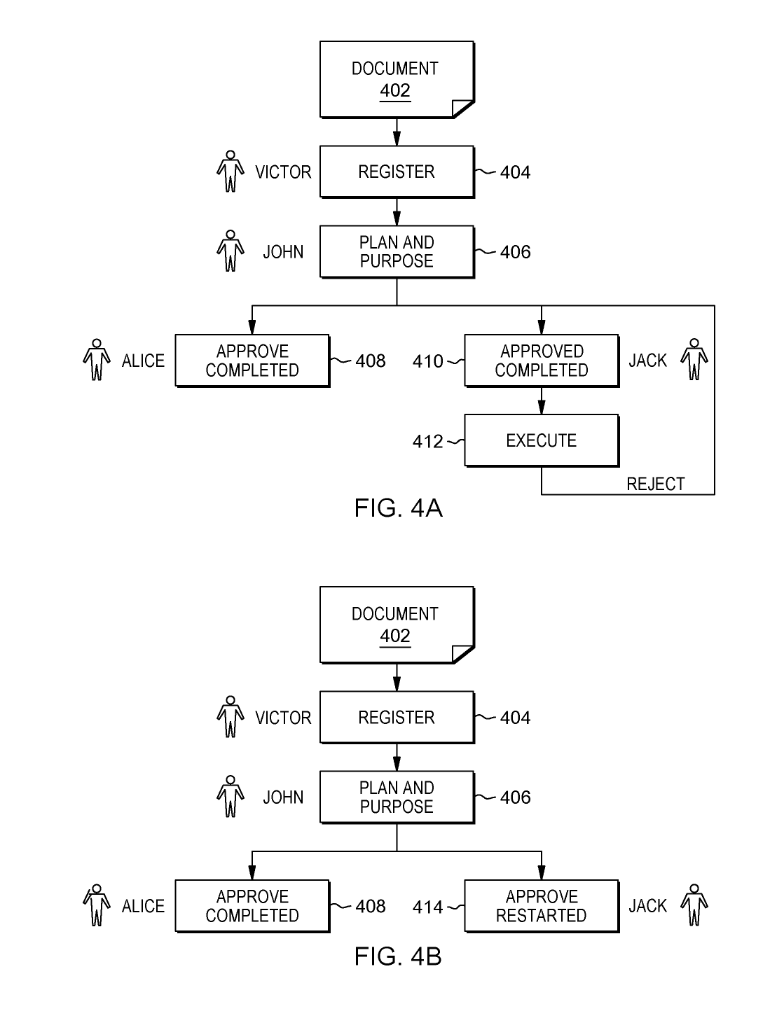

FIG. 3 illustrates a functional block diagram, generally designated 300, of a task engine in a task management software, on a server computer within the task management environment of FIG. 1, in an embodiment in accordance with the present invention. The example embodiment of FIG. 3 illustrates one implementation of task engine 302 in Task management software 110. Task 206, also shown in FIG. 2, contains flow trigger 318, flow properties 320 and payload 326 as depicted in FIG. 3. Task engine 302, containing event handler trigger 314 and task event handler 316, is responsible for handling task object (e.g., task 206) events by examining a payload of the event (e.g. flow trigger 318) to decide what happened to the specific task object. For example, the event may notify task engine 302 that a user executed a “complete” operation for task 206. Task engine 302 checks whether there is any additional information from the event payload. For example, task engine 302 may determine whether the user issued additional commands such as “jump to other task step”, or “launch other task flow”. The task engine may additionally check event-driven rules 112, to determine if there are any rules defined for the event. If there are rules defined for the event, task engine 302 may follow the rules to execute the additional operations. In other example embodiments, there may be more than one event handler trigger 314 and/or task event handler 316 in task engine 302.

Task 206's event, also referred to as flow trigger 318, is the trigger of the flow step indicated by reference 308 and is received by event handler trigger 314. Upon receiving the event, task engine 302 follows steps 310, 312, and 314 to launch the next task step or update previous task step. Stated another way, flow trigger 318 is the object associated event registration and launch mechanism for task 206, and task engine 302 is the handler of flow trigger 318 and determines one or more next operations following event-driven rules 112, the event payload, and/or flow properties 320. Task engine 302 processes task 206 using flow properties contained in task 206 and event-driven rules 112 that describe the implementation task flow rules depicted in FIG. 2. Task 304 may be a next task, or a child task launched by a user and also contains a flow trigger 322 and flow properties 324. Task 206 also contains payload 326 that is used to store information pertaining to task 206, such as one or more task owners, status indicators for one or more sub-tasks or child tasks, a next task indicator, a previous or predecessor task indicator, one or more sub-task or child task indicators, and one or more next task or successor tasks.

For example, a user performs a “complete” operation on task 206 and flow properties 320 is updated to indicate the status of task 206 and one or more next steps may be indicated. Flow trigger 318 may then notify event handler trigger 314 of the “completion” event. Event handler trigger 314 reads flow trigger 318 and then hands off processing of task 206 to task event handler 316. Task event handler 316 uses task 206 flow properties and event-driven rules 112 to process task 206. For example, task event handler 316, using flow properties 320 and event-driven rules 112, may begin processing task 304 as the next step in the “approval” process. Task 304 contains flow trigger 322, flow properties 324, and payload 328 as depicted in FIG. 3.

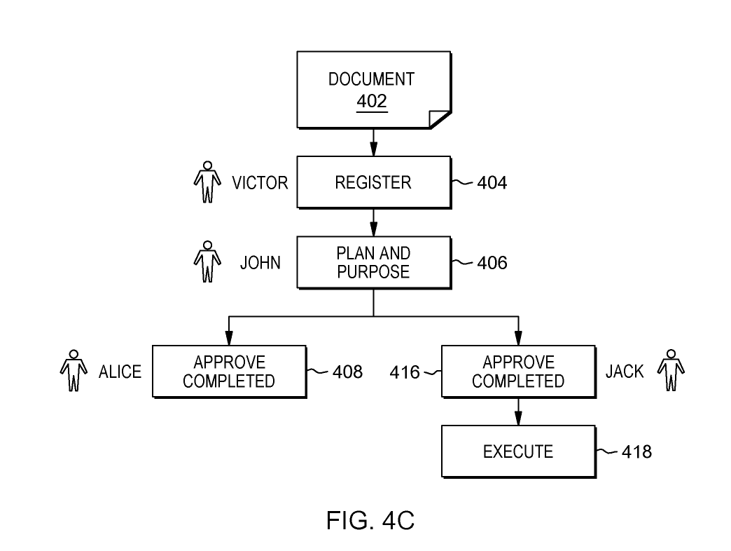

FIG. 4A is a flowchart depicting operational steps of a task management software, on a server computer within the task management environment of FIG. 1, for processing an event payload of a user task object to execute a reject command in an embodiment in accordance with the present invention. In an example embodiment, document 402 is submitted in task management environment 100 by a user to be registered, planned, approved, and executed by one or more task owners as depicted in FIG. 4A (where “register”, “plan”, “approve”, and “execute” are tasks—with associated task objects—that are included in the task flow for document 402). Document 402 is received, and “registered” by task owner “Victor” as depicted in step 404. Upon completing the registration process by “Victor”, task engine 302 is notified of the event (i.e., registering document 402), by the flow trigger of the task object for document 402. For example, “Victor” completes the registration process and may click on a “Register” button using a user interface (not shown) on computer 116. The flow trigger in the task object for document 402 may then notify task engine 302 of the registration. Task engine 302 then reads the flow properties and payload in the task object for document 402, and determines if any rules are defined for the task in event-driven rules 112 to determine the next step in the process.

Upon determining the next step in the process, task engine 302 assigns document 402 to task owner “John” to “plan and propose” as depicted in step 406. An example of a rule, or property, task engine 302 may use to determine the next step can be seen in the following (Code Snippet 1):

```
Code Snippet 1—Next Task
″DefaultRouting″: [
  {
    ″Index″: 0,
    ″Expression″: ″True″,
    ″DefNextTaskWG″: ″Taskowners″,
    ″DefNextTaskOwner″: ″John″,
    ″NextTaskName″: ″Plan & Propose″,
    ″NextTaskType″: ″BTF_niban″
  }
]
```

The default routing defined for document 402 indicates “John” as the default next task owner and the name of the next task as “Plan & Propose”. Using the information above, task engine 302 may route the task to “John” for continued processing of the next step.

In response to “John” completing the “Plan & Propose” step, task engine 302 routes document 402 to next task owners “Alice” and “Jack” for “Approval” as depicted in step 408 and 410. Based on his experience, “John” decides NOT to follow the task management software 110 event-driven rule 112 to launch default next task, but to manually assign two “Approve” tasks to task owners “Alice” and “Jack” as the tasks following “Plan & Propose”. Additionally, “John” requires both Alice and Jack to work as a team to complete the approval, and no next task can be triggered until both of them complete the approval of document 402. When all tasks within the team are complete, the completion event of the last task (e.g., predecessor tasks, child tasks, and parent task), of the team may trigger the next task according to event-driven rules 112.

Continuing the example embodiment of FIG. 4A, “Jack” decides to manually launch the next task “Broadcast Review” (not shown) and “Execute” in step 412, and do a manual assignment but not to follow the default rule or rules in event-driven rules 112. Task engine 302 may then restart the “Approve” task for Jack due to the “Reject” operation as depicted in FIG. 4A and the restart of task owner “Jack's” “Approval” as depicted in step 414 of FIG. 4B. In other example embodiments, task owners of may be notified of the rejection cause by task owner “Jack”.

FIG. 4B is a flowchart depicting operational steps of a task management software, on a server computer within the task management environment of FIG. 1, for restarting a user's task due to a reject operation in an embodiment in accordance with the present invention. Continuing the example embodiment of FIG. 4A, task engine 302 routes document 402 to next task owner “Jack” for “Approval” as depicted in step 414. Upon completing all tasks within the team, the completion event of the last task of the team (e.g., “Alice” and “Jack”), may trigger the next task according to event-driven rules 112.

FIG. 4C is a flowchart depicting operational steps of a task management software, on a server computer within the task management environment of FIG. 1, for resuming a user task object after a reject command in an embodiment in accordance with the present invention. Continuing the example embodiment of FIGS. 4A and 4B, task owner “Jack” completes the restarted “Approval” operation and submits, or completes, the task as depicted in step 416. Task engine 302, upon receiving the event trigger, determines any existing rules for the task then routes document 402 to the task owner of the “Execute” task (not shown) to perform the next steps in executing the task as depicted in step 418. In one example embodiment, the owner of the “Execute” task may need other task owners to assist in the execution of the “Execute” task. The owner of the “Execute” task may, on the fly, assign one or more sub-tasks, or child tasks, to one or more additional users to assist in completing the task. The completion status of the one or more sub-tasks will automatically sync-up to the parent “Execute” task. As the one or more sub-tasks are completed, the parent “Execute” task is updated to reflect the completion of the one or more sub-tasks.

It should be noted that FIGS. 4A, 4B, and 4C are sample tasks used in a task management software flow, and “Register”, “Approve”, “Execute” are just sample tasks used in task flow. Task engine 302 works on the backend to control the reject or withdraw operation. The event payload, (i.e., the trigger), allows task engine 302 to understand the command from a user to a task object (e.g., “reject” or withdraw”), and task engine 302 may follow the command from user to operate the current task, and also check the pre-defined task flow rules to decide what to do next after rejecting or withdrawing the current task (“Task A”). For example, task engine 302 may restore the previous task according to history information stored in the “Task A”. In one example embodiment, task management software 110 may be enhanced to allow, during the time the task is being designed, the ability to define or display the event-driven relationship between task types, such as “Register”, “Plan”, Approve”, and “Execute”. In another example embodiment, task management software 110 may be enhanced to illustrate the processing history of a task. For example, the history of the task may be viewed in a graphic format such as a flow or a tree history view.

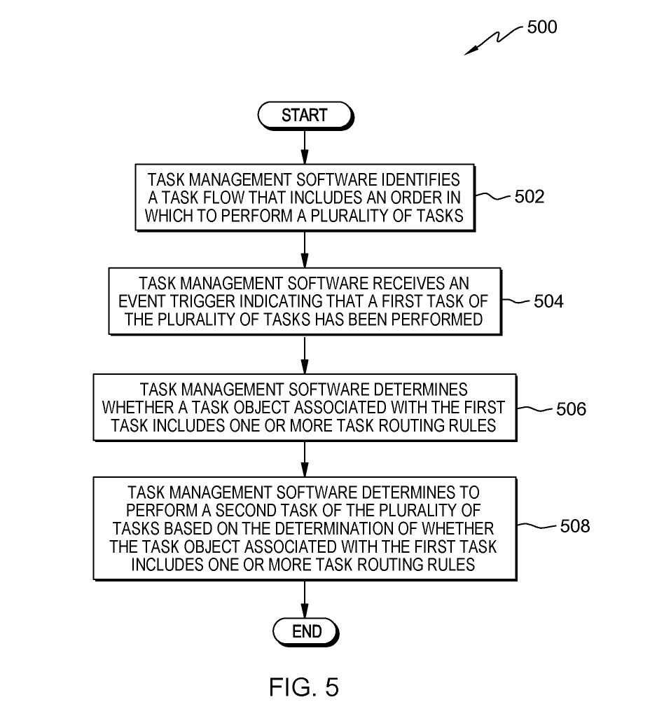

FIG. 5 is a flowchart, generally designated 500, depicting operational steps of a task management flow, on a server computer within the task management environment of FIG. 1, for performing a runtime based dynamic routing of a business task flow in an embodiment in accordance with the present invention. In one example embodiment, task management software 110 may identify a task flow that includes an order in which to perform a plurality of tasks as depicted in step 502. For example, the task flow may indicate one or more sub-tasks, or child tasks, such as task 210. The task flow may also indicate one or more next tasks, or successor tasks such as task 204.

In step 504, task management software 110 receives an event trigger indicating that a first task of the plurality of tasks has been performed (i.e., completed). For example flow trigger 318 notifies task engine 302 indicating task 206 is completed. In another example embodiment, upon completing all tasks within a team, such as “Alice” and “Jack” in FIGS. 4A-4C, the completion event of the last task in the team will trigger the next task “Execute” according to event-driven rules 112.

Task management software 110 determines whether a task object associated with the first task includes one or more task routing rules as depicted in step 506. For example, task engine 302 may examine the task object to determine if a next task is identified, such as successor task, in task 206. Task engine 302 may also determine if one or more task rules are defined for the task in event-driven rules 112. In other example embodiments, task engine 302 may examine the task flow properties field (e.g., flow properties 320), and the task payload when determining the one or more task routing rules.

In step 508, task management software 110 determines to perform a second task of the plurality of tasks based on the determination of whether the task object associated with the first task includes one or more task routing rules. For example, upon determining that a next task is defined in a task routing rule for the first task, task engine will trigger the next task, such as task 304 in FIG. 3. In other example embodiments, where the owner of the first task may require assistance in completing the first task, the task owner may “on the fly” create one or more sub-tasks and assign the one or more sub-tasks to other task owners via a task routing rule. The completion status of the one or more sub-tasks will automatically sync up to the parent task upon completion. Task engine 302 will ensure all sub-tasks are completed before triggering any next tasks, or successor tasks.

Alternatively, if task management software 110 determines that the task object associated with the first task does not include any task routing rules (or determines that the tasks in any task routing rules have been completed), task management software 110 determines to perform a second task according to the order in the identified task flow. In other words, absent any task routing rules for the first task, task management software 110 will continue performing tasks in the order defined in the task flow.

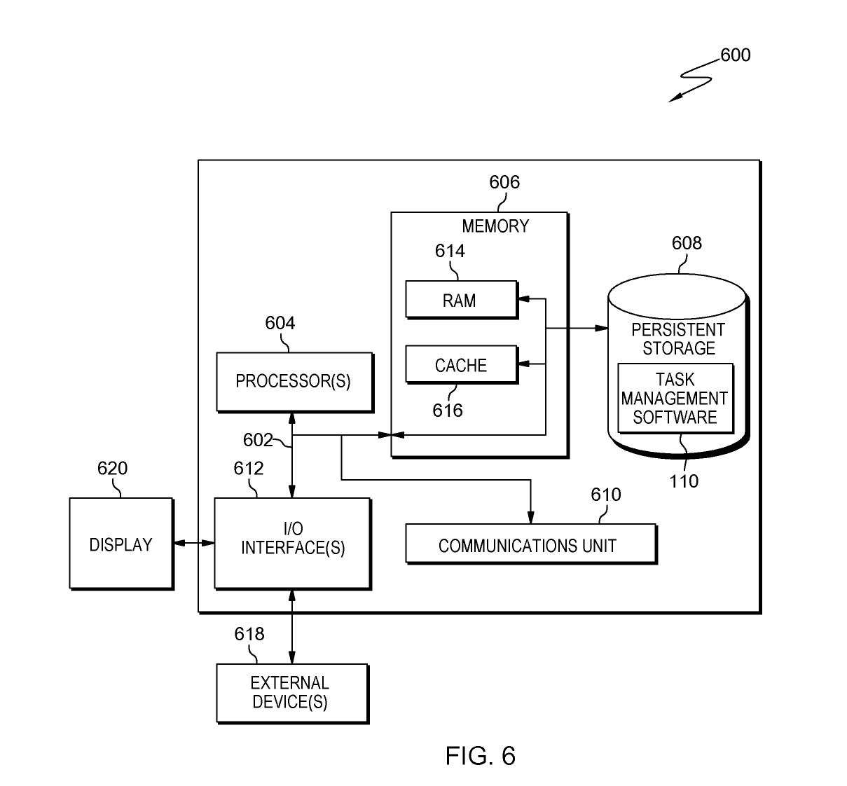

FIG. 6 depicts a block diagram, generally designated 600, of components of the server computer executing task management software, in an embodiment in accordance with the present invention. It should be appreciated that FIG. 6 provides only an illustration of one implementation and does not imply any limitations with regard to the environments in which different embodiments may be implemented. Many modifications to the depicted environment may be made.

Server 102 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer readable storage media. In this embodiment, memory 606 includes random access memory (RAM) 614 and cache memory 616. In general, memory 606 can include any suitable volatile or non-volatile computer readable storage media.

Task management software 110 is stored in persistent storage 608 for execution by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices, including resources of network 114 and computer 116. In these examples, communications unit 610 includes one or more network interface cards. Communications unit 610 may provide communications through the use of either or both physical and wireless communications links. Task management software 110 may be downloaded to persistent storage 608 through communications unit 610.

I/O interface(s) 612 allows for input and output of data with other devices that may be connected to server 102. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., Task management software 110, can be stored on such portable computer readable storage media and can be loaded onto persistent storage 608 via I/O interface(s) 612. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
creating, by one or more computer processors, one or more task objects in a business process management system, wherein each task object is a data structure that corresponds to a task of a predefined task flow, wherein the predefined task flow includes an order in which to perform a plurality of tasks, and wherein the task objects include information pertaining to predecessor tasks and successor tasks, identified from the predefined task flow, and task ownership;
determining, by one or more computer processors, to perform a first task of the plurality of tasks according to a first task object corresponding to the first task, wherein the first task object includes information identifying a second task of the plurality of tasks as a successor task of the first task, identified from the predefined task flow, and wherein the first task object includes information identifying a first user as an owner of the first task;
receiving, by one or more computer processors, an event trigger indicating that the first task has been performed by the first user;
receiving, by one or more computer processors, user input from the first user, wherein the user input indicates a reassignment of the second task to a second user, wherein the second user is different from an owner of the second task, identified from the predefined task flow;
responsive to receiving the user input indicating the reassignment of the second task to the second user, creating, by one or more computer processors, one or more task routing rules for implementing the reassignment without modifying the predefined task flow; and
reassigning, by one or more processors, the second task to the second user according to the one or more task routing rules, wherein the reassigning includes updating a second task object corresponding to the second task to include information identifying the second user as the owner of the second task.

2-3. (canceled)

4. The computer-implemented method of claim 1, further comprising:
receiving an event trigger indicating that the second task has been performed by the second user;
responsive to receiving the event trigger indicating that the second task has been performed by the second user, determining to perform a third task of the plurality of tasks, wherein the third task is a task that follows the second task in the order of the predefined task flow.

5. The computer-implemented method of claim 1, further comprising creating, by one or more processors, one or more additional task routing rules based on additional user input from the first user.

6. The computer-implemented method of claim 5, wherein the one or more additional task routing rules include a rule for skipping a task of the plurality of tasks in the order of the predefined task flow.

7. (canceled)

8. A computer program product comprising:
one or more computer readable storage media and program instructions stored on the one or more computer readable storage media, the program instructions comprising:
program instructions to create one or more task objects in a business process management system, wherein each task object is a data structure that corresponds to a task of a predefined task flow, wherein the predefined task flow includes an order in which to perform a plurality of tasks, and wherein the task objects include information pertaining to predecessor tasks and successor tasks, identified from the predefined task flow, and task ownership;
program instructions to determine to perform a first task of the plurality of tasks according to a first task object corresponding to the first task, wherein the first task object includes information identifying a second task of the plurality of tasks as a successor task of the first task, identified from the predefined task flow, and wherein the first task object includes information identifying a first user as an owner of the first task;
program instructions to receive an event trigger indicating that the first task has been performed by the first user;
program instructions to receive user input from the first user, wherein the user input indicates a reassignment of the second task to a second user, wherein the second user is different from an owner of the second task, identified from the predefined task flow;
program instructions to, responsive to receiving the user input indicating the reassignment of the second task to the second user, create one or more task routing rules for implementing the reassignment without modifying the predefined task flow; and
program instructions to reassign the second task to the second user according to the one or more task routing rules, wherein the reassigning includes updating a second task object corresponding to the second task to include information identifying the second user as the owner of the second task.

9-10. (canceled)

11. The computer program product of claim 8, further comprising:
program instructions to receive an event trigger indicating that the second task has been performed by the second user;
program instructions to, responsive to receiving the event trigger indicating that the second task has been performed by the second user, determine to perform a third task of the plurality of tasks, wherein the third task is a task that follows the second task in the order of the predefined task flow.

12. The computer program product of claim 8, further comprising creating, by one or more processors, one or more additional task routing rules based on additional user input from the first user.

13. The computer program product of claim 12, wherein the one or more additional task routing rules include a rule for skipping a task of the plurality of tasks in the order of the predefined task flow.

14. (canceled)

15. A computer system comprising:
one or more computer processors;
one or more computer readable storage media;
program instructions stored on the computer readable storage media for execution by at least one of the one or more processors, the program instructions comprising:
program instructions to create one or more task objects in a business process management system, wherein each task object is a data structure that corresponds to a task of a predefined task flow, wherein the predefined task flow includes an order in which to perform a plurality of tasks, and wherein the task objects include information pertaining to predecessor tasks and successor tasks, identified from the predefined task flow, and task ownership;
program instructions to determine to perform a first task of the plurality of tasks according to a first task object corresponding to the first task, wherein the first task object includes information identifying a second task of the plurality of tasks as a successor task of the first task, identified from the predefined task flow, and wherein the first task object includes information identifying a first user as an owner of the first task;
program instructions to receive an event trigger indicating that the first task has been performed by the first user;
program instructions to receive user input from the first user, wherein the user input indicates a reassignment of the second task to a second user, wherein the second user is different from an owner of the second task, identified from the predefined task flow;
program instructions to, responsive to receiving the user input indicating reassignment of the second task to the second user, create one or more task routing rules for implementing reassignment without modifying the predefined task flow; and
program instructions to reassign the second task to the second user according to the one or more task routing rules, wherein the reassigning includes updating a second task object corresponding to the second task to include information identifying the second user as the owner of the second task.

16-17. (canceled)

18. The computer system of claim 15, further comprising:
program instructions to receive an event trigger indicating that the second task has been performed by the second user;
program instructions to, responsive to receiving the event trigger indicating that the second task has been performed by the second user, determine to perform a third task of the plurality of tasks, wherein the third task is a task that follows the second task in the order of the predefined task flow.

19. The computer system of claim 15, further comprising creating, by one or more processors, one or more additional task routing rules based on additional user input from the first user.

20. The computer system of claim 19, wherein the one or more additional task routing rules include a rule for skipping a task of the plurality of tasks in the order of the predefined task flow.

21. The computer-implemented method of claim 5, wherein the one or more additional task routing rules replace the second task with a third task as the successor task of the first task in the first task object.

22. The computer-implemented method of claim 5, wherein the one or more additional task routing rules add a third task as a sub-task of the first task in the first task object, the third task to be performed before performing the second task identified as the successor task of the first task in the first task object.

23. The computer program product of claim 12, wherein the one or more additional task routing rules replace the second task with a third task as the successor task of the first task in the first task object.

24. The computer program product of claim 12, wherein the one or more additional task routing rules add a third task as a sub-task of the first task in the first task object, the third task to be performed before performing the second task identified as the successor task of the first task in the first task object.

25. The computer system of claim 19, wherein the one or more additional task routing rules replace the second task with a third task as the successor task of the first task in the first task object.

26. The computer system of claim 19, wherein the one or more additional task routing rules add a third task as a sub-task of the first task in the first task object, the third task to be performed before performing the second task identified as the successor task of the first task in the first task object.

27. The computer-implemented method of claim 1, wherein the received user input from the first user indicates a reassignment of the second task to a third user in addition to the second user, and wherein the method further comprises:
upon receiving an event trigger indicating that the second task has been performed by both the second user and the third user, determining, by one or more computer processors, to perform a third task that is a successor task for the second task, as identified in the second task object.

28. The computer program product of claim of claim 8, wherein the received user input from the first user indicates a reassignment of the second task to a third user in addition to the second user, and wherein the program instructions further comprise:
program instructions to, upon receiving an event trigger indicating that the second task has been performed by both the second user and the third user, determine to perform a third task that is a successor task for the second task, as identified in the second task object.

29. The computer system of claim 15, wherein the received user input from the first user indicates a reassignment of the second task to a third user in addition to the second user, and wherein the program instructions further comprise:
program instructions to, upon receiving an event trigger indicating that the second task has been performed by both the second user and the third user, determine to perform a third task that is a successor task for the second task, as identified in the second task object.
